(19) United States
(12) Patent Application Publication
(10) Pub. No.: US 2005/0186950 A1
(43) Pub. Date: Aug. 25, 2005

(54) Method and system for telephone number portability between fixed and wireless networks

(76) Inventor: Yue Jun Jiang, Danville, CA (US)

Correspondence Address: SHEMWELL GREGORY & COURTNEY LLP, 4880 STEVENS CREEK BOULEVARD, SUITE 201, SAN JOSE, CA, 95129, US

(21) Appl. No.: 11/063,446

(22) Filed: Feb. 23, 2005

Related U.S. Application Data
(60) Provisional application No. 60/547,005, filed on Feb. 23, 2004.

(51) Int. Cl. H04M 3/42

(52) U.S. Cl. 455/417

(57) ABSTRACT

A method and system for telephone number portability between fixed line networks and wireless networks. Embodiments include porting a number between a fixed line operator (“FLO”) and a mobile operator (“MO”). Embodiments include a Service Control Point (“SCP”) that communicates with the FLO and the MO to facilitate number porting. Embodiments support a direct ISUP connection between the FLO network and the MO network, or the lack thereof. Embodiments include routing a call to a fixed-line phone on a per subscriber basis first before the call is routed to the wireless network under certain conditions (e.g. no-answer of the fixed-line phone). In one embodiment, a special forwarding number is applied as an indicator for a ported number.

### RELATED APPLICATIONS

The application claims the benefit of U.S. Provisional Application Ser. No. 60/547,005, filed Feb. 23, 2005, which is incorporated by reference herein in its entirety.

### TECHNICAL FIELD

The disclosed embodiments relate to fixed and wireless communication networks and devices for voice and data communication.

### BACKGROUND

Existing approaches to phone number portability among fixed line operators and mobile operators typically rely on switch network element upgrades in both the fixed and mobile networks of concerned parties. Existing approaches also usually use a number portability range as an indicator for a possibly ported number. However, more recently all numbers are allowed to port, which makes the number portability range approach non-scalable.

| Acronym/ | |
|---|---|
| Abbreviation | Description |
| APMN | Associated Public Mobile Network for SMS Inter-working |
| CDR | Call Detail Record |
| CFB | Call Forwarding in Busy |
| CFNR | Call Forwarding on Not Reachable |
| CFNRy | Call Forwarding on No Reply |
| CFU | Call Forwarding Unconditional |
| FTN | Forwarded-To-Number typically used in Call Forwarding |
| GMSC | Gateway MSC |
| GT | Global Title (SS7 parlance) |
| GTT | Global Title Translation |
| HLR | Home Location Register |
| HPMN | Home Public Mobile Network who intends to provide |
| | this service |
| IAM | Initial Address Message |
| IMSI | International Mobile Subscriber Identity (of HPMN) |
| IN | Intelligent Network |
| INAP | Intelligent Network Application Part |
| IOSMS | Inter Operator SMS within HPMN |
| ISUP | ISDN User Part message from SS7 stack |
| IVR | Interactive Voice Response |
| LCF | Late Call Forwarding |
| LRN | Location Routing Number |
| MAP | Message Application Part - from GSM 09.02 GSM |
| | Standards |
| MGT | Mobile Global Title (derived from IMSI) |
| MSC | Mobile Switching Center |
| MIB | Management Information Base |
| MSISDN | Mobile Subscriber ISDN Number (phone number) |
| MSRN | Mobile Station Roaming Number |
| NPA-NXX | Network Planning Area code and Network exchange codes |
| OCN | Originally Called Number. Same as ODN |
| ODN | Originally Dialed Number. Same as OCN |
| PRN | Provide Roaming Number MAP message |
| SCCP | Signal Control Connection Part |
| SCP | Signal/Service Control Point |
| SN | Service Node for ring-back-tone service. |
| SS7 | Signaling System 7 |
| SRI | Send Routing Information MAP message |
| SMS | Short Message Service |
| SMSC | Short Message Service Center |
| SNMP | Simple Network Management Protocol |
| TT | Translation Type (SS7 parlance) |
| VLR | Visited Location Register |
| VMSC | Visited Mobile Switching Center |
| VPMN | Visited Public Mobile Network (other than HPMN or |
| | FPMN) |

### BREIF DESCRIPTION OF THE DRAWINGS

FIG. 1 is a block diagram of an embodiment of a system for telephone number portability between fixed and wireless networks.

FIG. 2 is a block diagram of a signal flow according to an embodiment in which a call forwarding option is used with ISUP signaling.

FIG. 3 is a block diagram of a signal flow according to another embodiment in which a non-forwarding option is used with ISUP signaling.

FIG. 4 is a block diagram of a signal flows according to an embodiment for call forwarding with IN signaling.

FIG. 5 is a block diagram of a signal flows according to an embodiment for non-forwarding with IN signaling.

FIG. 6 is a block diagram of an embodiment of a call flow in which A calls B where B is a ported number.

FIG. 7 is a block diagram of an embodiment that supports porting to a wireless phone only when the call is originated from the Mobile Operator.

FIG. 8 is a block diagram of an embodiment that supports an international third party SMSC sending a SMS to a B# in the MO network.

FIG. 9 is a block diagram of an embodiment in which the SCP contains a GTT function that translates the CdPA of a true ported B# into a corresponding HLR GT address or point code.

FIG. 10 is a block diagram of an embodiment in which the MO GMSC introduces a new translation type.

### DETAILED DESCRIPTION

Embodiments described herein include a system and method for porting a number between a fixed line operator (“FLO”) and a mobile operator (“MO”). Embodiments of the invention are applicable to any country where the fixed numbers and wireless numbers are not distinguishable, such as the United States. Many countries still separate fixed numbers from wireless numbers, perhaps due to the “Calling party pays” model, and the expectation that calling a mobile number is more expensive than calling a fixed line number. In the future, however, such distinctions are expected to be eliminated.

Embodiments described herein are completely switch and HLR independent. The approach of the embodiments uses standard features of switches and does not require any switch or HLR modifications, or a global number portability database (“DB”) in order to support the number portability. The approach only requires the MO's GMSC to host and interface an embodiment of a Service Control Point (“SCP”) as described herein. In one embodiment, there is a direct ISUP connection between the FLO network and the MO network. The FLO may perform provisioning and bill settlement with the MO. Embodiments also support cases in which there is no ISUP parameters guarantee between the FLO network and the MO network. In this case, there are signal interfaces from both the FLO network and the MO network to an embodiment of a SCP.

In various embodiments, the approach includes routing the call to a fixed-line phone on a per subscriber basis first before the call is routed to the wireless network under certain conditions (e.g. no-answer of the fixed-line phone). The FLO can therefore still charge the line connection fee if the subscriber also uses the fixed line phone to make calls at home. This also resolves the issue of which wireless number to port to in a case where a family uses a common fixed line, but only one of the family members uses a mobile phone In one embodiment, a special forwarding number is applied as an indicator for a ported number in order to deal with the problem of low density of ported numbers in a large number portability range.

For purposes of describing the various embodiments, assume hypothetically that the FLO is involved in a joint venture with the MO to roll out a GSM service in the GSM 1900 band. Further assume that currently the MO only has a small number of subscribers. Supporting mobile number portability will help the MO increase its subscriber base. Assume the FLO has a relatively large number of fixed line subscribers. In an embodiment, the FLO supports the porting of the fixed line numbers to its partner MO operations so subscribers will have a mobile number that is the same as their existing fixed line number. Thus, the MO can significantly increase its mobile subscriber base and position itself as a strong contender in a competitive market. This example scenario, which will be used to illustrate embodiments, exists in various parts of the world. Typically, the FLO and the MO do not have any infrastructure features supporting number portability. Embodiments described herein provide a number portability service using standard signaling. Embodiments described herein do not assume a switch (PSTN or mobile) or HLR supporting number portability, a signal relay function, or a global number portability DB. Embodiments as described herein do not assume end to end ISUP trunking between the FLO network and MO network. At the same time, calling information (e.g. caller ID) delivery is guaranteed. In the case of an end-to-end ISUP trunking between the FLO network and the MO network, embodiments only interface with the MO network and eliminate any interfaces with the FLO network, but the invention is not so limited.

It is attractive to subscribers to be able to turn their fixed line numbers into wireless numbers. However, the FLO and the MO probably desire the option to route a call to the fixed line phone first on a per subscriber basis before the call goes to the wireless network under certain conditions. Embodiments support this flexibility. The subscriber can still receive and make calls on his fixed line phone (e.g. when he is at home), therefore cutting down airtime cost and providing convenience to multiple users in a family environment. However, when the fixed line phone is not answered, the call is routed to the subscriber's mobile phone. In this way, the FLO's fixed line business is somewhat protected because the subscriber will still want the fixed line connection.

In one embodiment, the subscriber can turn off rerouting to the mobile phone. For example, the subscriber may allow the call to be answered by an answering machine, to be routed to voicemail or to be routed to another phone. This is ideal for families which use the mobile phone for emergencies only.

Embodiments described herein are useful in both the calling party pay model and the called party pay model for mobile terminated local call airtime. For both models, when the subscriber is at home, she can make calls using the fixed line phone.

Embodiments of the invention are effective where an A# and a B# are in the same area code. The embodiments described are completely independent of the A# (whether the A# shares the same fixed line exchange with the B# or not) since signaling triggering and signaling are only done on the B#. For example, A calls B where B is a ported number. In a call forwarding scenario as described further herein, assume B sets call forwarding to the special number, # C, for the case of the fixed-line phone not being answered. The call on B is routed normally to B's fixed line phone first. If the phone answers, it is no different from a non-ported number. If B is not answering however, the FLO switch forwards the call on the C#. In one embodiment, the FLO switch routes the call on the C# to a tandem switch which then issues signaling (ISUP loopback) to the SCP which then returns a routing number for the switch to route the call to the wireless side.

Embodiments use a single number for both fixed-line and the wireless line, thus avoiding confusion caused by different numbers appearing on the receiving party's caller ID display. Embodiments support SMS to the single number.

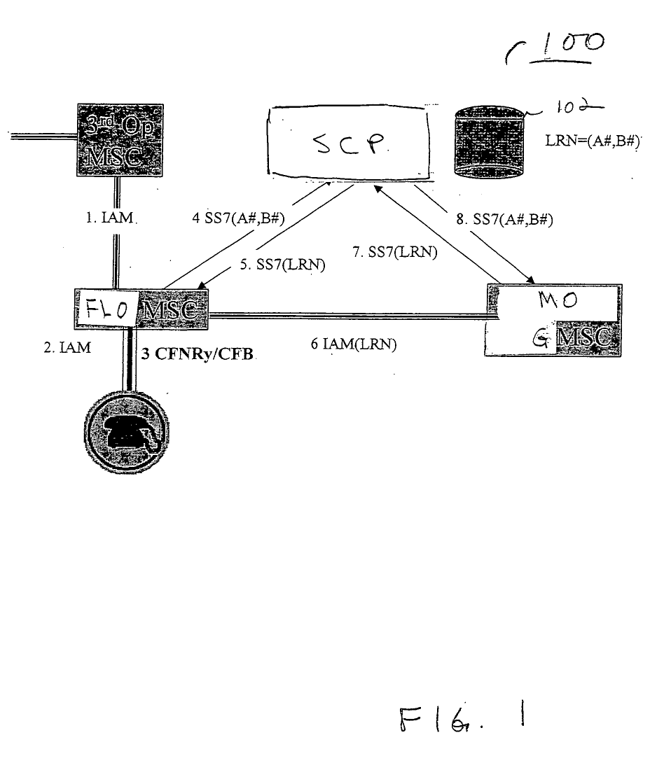

FIG. 1 is a block diagram of a system 100 for telephone number portability between fixed and wireless networks according to an embodiment. The system 100 includes a proprietary service node or service control point, referred to herein as a SCP. A FLO MSC can issue standard signaling to the SCP. A MO MSC can also issue standard signaling to the SCP. The SCP controls the routing and translation needed to achieve number portability. A third party MSC communicates an IAM to the FLO MSC.

An MSC (FLO MSC or MO MSC) is configured to trigger a SS7 signaling transaction with the SCP. When the ported number is called, the call goes to the fixed line network first. On certain triggering conditions (e.g. the fixed line phone is not answering) based on some triggering approaches described below, the fixed line network interfaces the SCP via SS7. The SCP returns a location routing number (LRN) from the number portability database 102 back to the FLO MSC. The LRN is selected from a pool, or is a common number that the fixed line switch routes to the wireless network where the phone number is ported in.

The fixed line switch FLO MSC then routes the call to the wireless network switch (MO MSC). In one embodiment, the MO MSC is a GSM 1900 switch. The MO MSC sends the control back to the SCP due to a special range of the LRN. The SCP returns the original A-party, B-party (or B's current location) numbers. The MO MSC then processes the call normally in the wireless network.

In one embodiment of system 100 it is assumed that there is no end-to-end ISUP trunking between the FLO network and the MO network. However because there is a direct ISUP connection between the FLO network and the MO network, ISUP information parameters such as Caller ID and OCN (Original Called Number) are not lost between the two networks. The MO network thus need only interface with the SCP. Two trigger options are described below according to such an embodiment, but the invention is not so limited.

One of the trigger options is a non-forwarding option according to which a number is potentially ported if it falls within a number range such as NPA-NXX. If the number is determined to be a possible ported-out number, a signaling message is issued to the SCP. In one embodiment, the SCP includes a local number portability DB. If the number is not really ported out, The SCP signals back to the switch to continue normal routing. If the number is ported out, the SCP returns a location routing number (LRN) to the MSC and builds up some association with the routing number in its DB (e.g. calling information).

In an embodiment, there is an option of routing the call back to the fixed-line phone first before routing the call on the LRN for the ported number under certain conditions (e.g. the fixed-line phone is not answering or busy) based on subscriber preferences. One advantage of this approach is it does not require call forward settings at the FLO MSC. However, another consequence of this approach is that number portability range could be all the FLO numbers. In this case, all signaling on FLO numbers would come to the SCP first. In an embodiment, the call is controlled by the SCP first before it is routed to the fixed-line node. In the case of ISUP loopback signaling, this also may require primary and secondary trunk routing configuration at the FLO switch.

Another trigger option includes a call forwarding indicator. In such an embodiment, there is no need to define a potentially ported number range. A number is considered to be ported out, if there is a forwarding on a special single global/common number C#. The special number is an indicator for the ported number. Note this is not forwarding to a different GSM number for each ported number.

The call on the ported number goes to the fixed line first based on subscriber preference. Only after call forwarding is triggered will the switch issue signaling to the SCP. The call forwarding can be unconditional forwarding or conditional forwarding if the fixed-line phone is not answering (or busy if the operator also desires this condition). The choice is based on subscriber preference. There can be a default call forwarding setting that is set by the FLO operator. In this embodiment, the signaling for all numbers will not go to the SCP. Only ported number's signaling goes to the SCP. In the case of ISUP loopback signaling, this does not require primary and secondary trunk routing configuration at the FLO switch. In particular, when the call is routed to the fixed line phone first, no trunking or loopback signaling to the SCP is required. Hence, this is a particularly resource-efficient approach. The forwarding settings may be defined at the FLO MSC switch for each ported number.

The FLO MSC routes the call using the routing number to the GMSC of the MO. The GMSC is configured to generate a SS7 signaling transaction with the SCP on the special range of routing numbers. The SCP returns the associated information (e.g., the original called number and calling number information) with the routing number. This guarantees calling information delivery even though the trunking between the FLO MSC and the MO GMSC may not guarantee such delivery. The LRN number is released to the pool for reassignment. The GMSC continues normal mobile terminated calls using the associated information.

The embodiments described are compatible with standard number portability solutions, but are evolutionary in the sense that they can also support switches that are not upgraded with number portability support.

For calls that originate from the MO network or non-call related signaling that originates or reaches the MO GMSC, if the B number in the ISUP call, or the CdPA address in SCCP addressing indicates a portability range, it is routed through the SCP via SS7 signaling. If the number is a non-ported number, normal routing is conducted. For example, if A in the MO network calls B, the MO GMSC recognizes B as a number in a portability range (e.g. via NPA_NXX from the FLO). The MO GMSC will issue SRI to the SCP. If the B# is indeed ported, the SCP issues SRI to HLR. If not, it returns the original number.

As another example, an international SMSC sends a SMS to a B# in the MO network. The FLO network has informed its roaming partners that the CC/NDC range of B# belong to the FLO. The SMSC issues SRI-SM to MO network. Because the CdPA # is in the range of portability, the signaling is redirected thru the SCP. The SCP checks whether the CdPA is a ported number. If it is, the SCP rewrites the CdPA to HLR; otherwise, the SCP rejects the SCCP message.

Two signaling options will be described, but are not intended to be exclusive. One option is termed a call forwarding option, and the other option is termed a non-forwarding option.

If the FLO switch supports IN, INAP signaling, IN_InitialDP will be sent to the SCP. The trigger is defined on DP3 (Info-analyzed) or DP2 (Collected-Info) on number range (e.g. NPA_NXX) in a portability range. The SCP issues IN_Continue if the called party number is not ported. Otherwise, the SCP assigns a free location routing number from a pool and builds up a DB association entry with the original called number and calling information (e.g. caller ID). The SCP then issues IN_Connect with the location routing number.

In some embodiments, the FLO switch is unlikely to support IN, so ISUP signaling is used. All calls on fixed line number go through normal routing first. If the forwarding number is C—the single global number that indicates portability, then the FLO switch issues ISUP signaling to the SCP.

The IN approach can be more efficient, but relies on switch support and switch variation. The ISUP loopback approach as described herein can be relatively less resource efficient, but does on depend on switch variation and IN support. IN or ISUP approaches may be chosen based on a variety of factors.

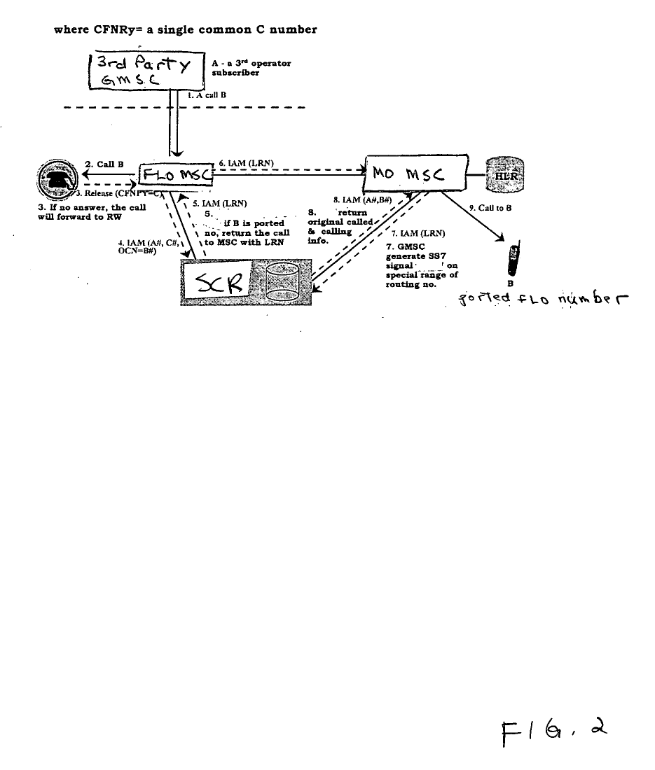

FIG. 2 is a block diagram of a signal flow according to an embodiment in which a call forwarding option is used with ISUP signaling. In the example of FIG. 2, the FLO MSC configures CFNRy on ported FLO numbers to a SCP, where CFNRy is a common C number. As shown with the reference number 1, a third party operator subscriber A calls party B from a third party operator GMSC. The call is routed to the FLO MSC. At 2, the FLO MSC calls B. If there is no answer, the call is forwarded to the SCP, and at 3 the CFNRy is released. At 4, an IAM (A#, C#, OCN=B#) is sent to the SCP. At 5, the SCP searches its DB, and is B is a ported number, the call is returned to the FLO MSC with IAM (LRN).

At 6, the FLO MSC sends IAM (LRN) to the MO GMSC. At 7, the MO GMSC generates an SS7 signal to the SCP on a special range of routing number, and sends an IAM (LRN) to the SCP. At 8, the SCP returns the original called number and calling information, and sends an IAM (A#, B#) to the MO GMSC. Then, at 9, the call is made to B on the ported FLO number from the MO GMSC.

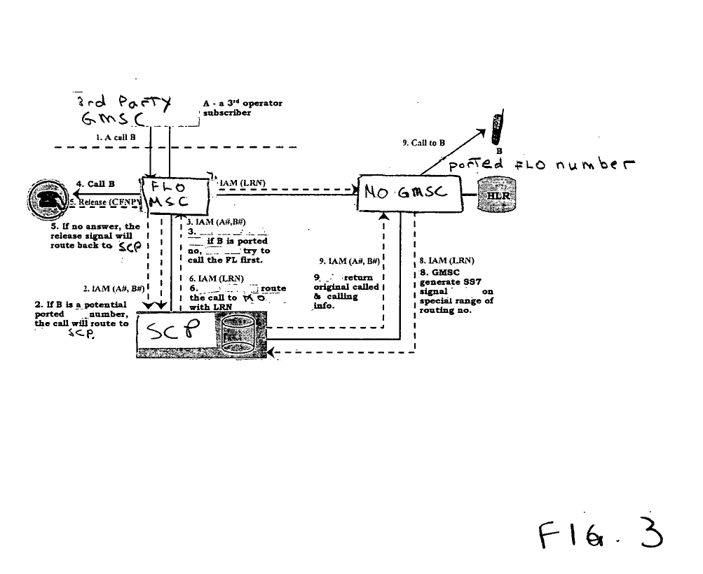

FIG. 3 is a block diagram of a signal flow according to another embodiment in which a non-forwarding option is used with ISUP signaling. In the example of FIG. 3, the FLO MSC routes all potentially ported Mobile Terminated calls to the SCP. For the non-forwarding option with ISUP signaling, the FLO MSC is configured with ISUP loopback trunks as primary and normal trunking as backup for the NPA_NXX in a portability range. When a called number falls into such a range, the signaling loops through the SCP with IAM(A#, B#). The SCP cranks back the call if the number is not ported. This will force the FLO MSC to try the secondary route (the normal route) automatically.

If the number is ported, the SCP assigns a free location routing number from a pool and builds up a DB association entry with the original called number and calling information (e.g. caller ID). The SCP then loops out on IAM (LRN).

Similarly, when the call on LRN from the FLO MSC reaches its MO GMSC, the signaling transaction with the SCP can be either IN or ISUP loopback. In both cases, the SCP uses the LRN to index its DB entry to return the associated original calling and called information.

Also the ISUP message between FLO MSC and MO GMSC does not have to be end-to-end, and does not have to support Generic Number or General Address Parameter or Original Called Number or FCI (forward call indicator) to Translated (Ported Number Translated Indicator). The embodiment also does not assume ISUP Release with cause indicator.

As shown with the reference number 1 in FIG. 3, a third party operator subscriber A calls party B from a third party operator GMSC. The call is routed to the FLO MSC. At 2, if B is a potential ported FLO number, the call is routed to the SCP. At 3, the SCP searches the DB, and if B is found to be a ported number, the SCP tries to call the fixed line first. At 4, the FLO calls B, and if there is no answer, a release signal (CFNPY) is routed back to the SCP as shown at 5. At 6, the SCP routes the call to the FLO MSC with IAM (LRN). At 7 the FLO MSC routes the call on to the MO GMSC with an IAM (LRN). At 8, the MO GMSC generates an SS7 signal to the SCP on a special range of routing number with IAM (LRN). At 9, the MO GMSC calls B using the ported FLO number. The SCP also returns the original called information and the original calling information to the MO GMSC with IAM (A#, B#) at 9.

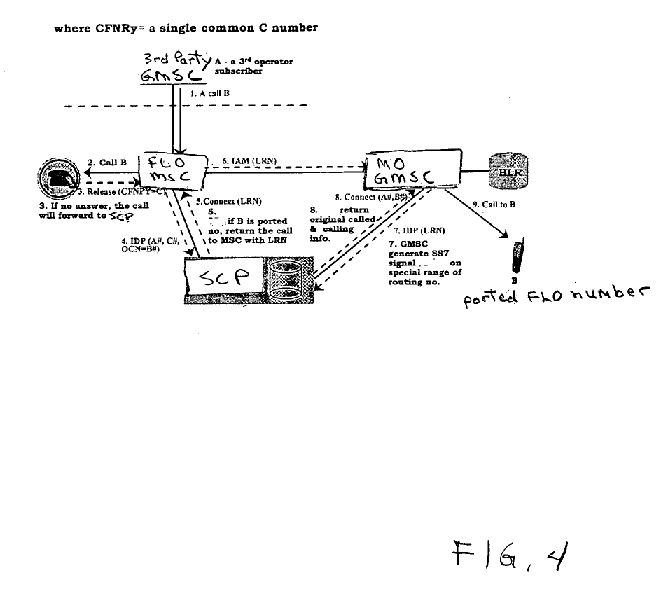

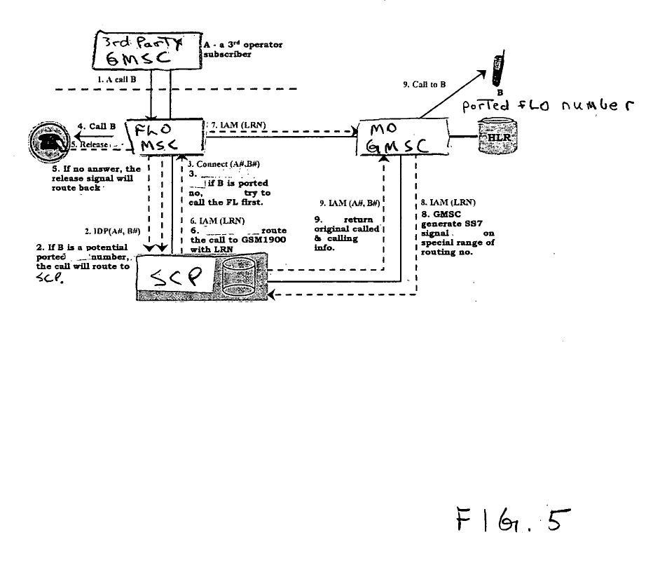

FIG. 4 and FIG. 5 are block diagrams of signal flows according to embodiments for call forwarding with IN signaling and non-forwarding with IN signaling, respectively.

FIG. 4 is a block diagram of a signal flows according to an embodiment for call forwarding with IN signaling. In the example of FIG. 4, the FLO MSC configures CFNRy on ported FLO numbers to a SCP, where CFNRy is a common C number. As shown with the reference number 1, a third party operator subscriber A calls party B from a third party operator GMSC. The call is routed to the FLO MSC. At 2, the FLO MSC calls B. If there is no answer, the call is forwarded to the SCP, and at 3 the CFNRy is released. At 4, an IDP (A#, C#, OCN=B#) is sent to the SCP. At 5, the SCP determines that B is a ported number, and the call is returned to the FLO MSC with Connect (LRN).

At 6, the FLO MSC sends IAM (LRN) to the MO GMSC. At 7, the MO GMSC generates an SS7 signal to the SCP on a special range of routing number, and sends IDP (LRN) to the SCP. At 8, the SCP returns the original called number and calling information, and sends Connect (A#, B#) to the MO GMSC. Then, at 9, the call is made to B on the ported FLO number from the MO GMSC.

FIG. 5 is a block diagram of a signal flows according to an embodiment for non-forwarding with IN signaling. As shown with the reference number 1 in FIG. 5, a third party operator subscriber A calls party B from a third party operator GMSC. The call is routed to the FLO MSC. At 2, if B is a potential ported FLO number, the call is routed to the SCP with ADP (A#, B#). At 3, the SCP searches the DB, and if B is found to be a ported number, the SCP tries to call the fixed line first. The SCP sends Connect (A#, B#) to the FLO MSC. At 4, the FLO calls B, and if there is no answer, a release signal (CFNPY/EDI) is routed back to the SCP as shown at 5. At 6, the SCP routes the call to the FLO with IAM (LRN). The FLO then routes the call on to the MO GMSC. At 8, the MO GMSC generates an SS7 signal to the SCP on a special range of routing number with IAM (LRN). At 9, the MO GMSC calls B using the ported FLO number. The SCP also returns the original called information and the original calling information to the MO GMSC with IAM (A#, B#) at 9.

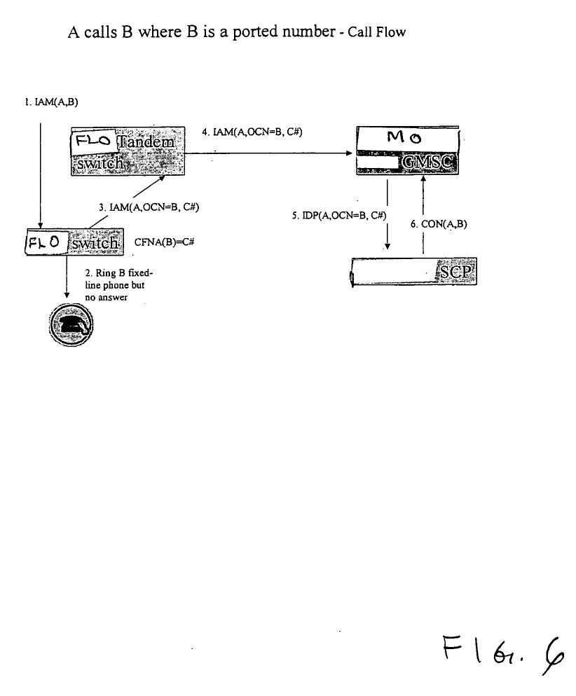

FIG. 6 is a block diagram of a call flow in which A calls B where B is a ported number. In FIG. 6, it is assumed that there is no end-to-end ISUP trunking between the FLO network and the MO wireless network. However because there is a direct ISUP connection between the FLO network and the MO network, ISUP information parameters such as Caller ID and OCN (Original Called Number) are not lost between two networks. In this embodiment, only the MO network interfaces with the SCP.

In one embodiment of the architecture, there is a SCP at the MO network. The SCP is connected to the MO GMSC that is directly connected to the FLO network via ISUP trunking. The GMSC can issue standard signaling to the SCP. The SCP controls the routing and translation needed to achieve number portability.

Using a call forwarding approach as a triggering option for number portability and IN for signaling to the SCP, as described above, a number is considered to be ported by the FLO if there is a forwarding set on a special single global C# belonging to the MO network. The special number is an indicator for the ported number. Note this is not forwarding to a different GSM number for each ported number.

When the call on a ported FLO number is not originated from the MO network, the call will be routed to a FLO fixed line MSC connected to the original fixed line phone of the ported number. Only after call forwarding is triggered, will the switch forward the call on the special C# to the MO GMSC that is directly connected to the FLO network. The call forwarding can be unconditional forwarding or conditional forwarding if the fixed-line phone is not answering (or busy if the operator also desires this condition). The choice is based on subscriber preference. There can be a default call forwarding setting by the FLO. An advantage of this approach is that no signaling interface is made to the SCP. The forwarding settings are defined at the FLO switch for each ported number.

The FLO MSC forwards the call using the C# to the MO GMSC over the direct ISUP link where the IAM message IAM(A, OCN=B, C) will not lose Calling number, OCN numbers via the ISUP trunking. The MO GMSC is configured to generate a IN/Camel SS7 signaling transaction with the SCP on the special number C#. If the original called number from the IN/Camel message on the special number C# is a ported number, as determined by checking its ported number DB, the SCP puts the original called number (i.e. the ported number) to called party field and routes the call back to the MO GMSC. The solution is compatible with standard number portability solutions, but evolutionary in the sense that it can also support switches that are not upgraded with number portability support.

For calls originated from the MO, or non-call related signaling that originates or reaches the MO GMSC, if the B number in the ISUP call or CdPA address in SCCP addressing indicates a portability range, it is routed thru the SCP via SS7 signaling. If the number is a non-ported number, normal routing is conducted. For example, if A in the MO network calls B, the MO GMSC recognizes B as a number in a portability range (e.g. via NPA_NXX from the FLO). The MO GMSC issues SRI to the SCP. If the B# is indeed ported, the SCP issues SRI to the HLR. If not, the SCP returns the original number. Alternatively, the MO network can always route the call to the fixed line network first, which will result in a simplified configuration at the MO network since it does not worry about whether a fixed line number is in the ported number range or not.

As another example, an international SMSC sends a SMS to a B# in the MO network. The MO has informed its roaming partners that CC/NDC range of B# belong to itself. The SMSC issues SRI-SM to the MO network. Because the CdPA # is in the range of portability, the signaling is redirected thru the SCP. The SCP checks if CdPA is a ported number. If it is, rewrites the CdPA to the HLR; otherwise, it rejects the SCCP message.

The MO GMSC supports Camel phase 2. The MO GMSC is armed with a Camel trigger on the special C#. The trigger is defined on DP2 (Collected-Info) on C#. When the call on the ported number B is being forwarded to the MO GMSC, the MO GMSC issues InitialDP (IDP) using Calling Number=A, OCN=B, CALLED #=C# to the SCP. The SCP can execute one of the following two options to CONNECT (CON) D# to instruct the GMSC to route the call on D#. As a first option, the SCP issues MAP SRI on the B# extracted from the OCN field from the IDP(A,OCN=B,C#). On obtaining MSRN from the HLR, it issues CONNECT(A,MSRN) to the GMSC. As another option, the SCP issues CON (A,B) to the GMSC. The GMSC will operate as if the call on the ported number B originates from the Thai Mobile network as described later.

Alternatively, if the B number in the ISUP call from the MO network side is in a portability range, it is still routed normally to the fixed line network first. This does not require special treatment on the MO network side.

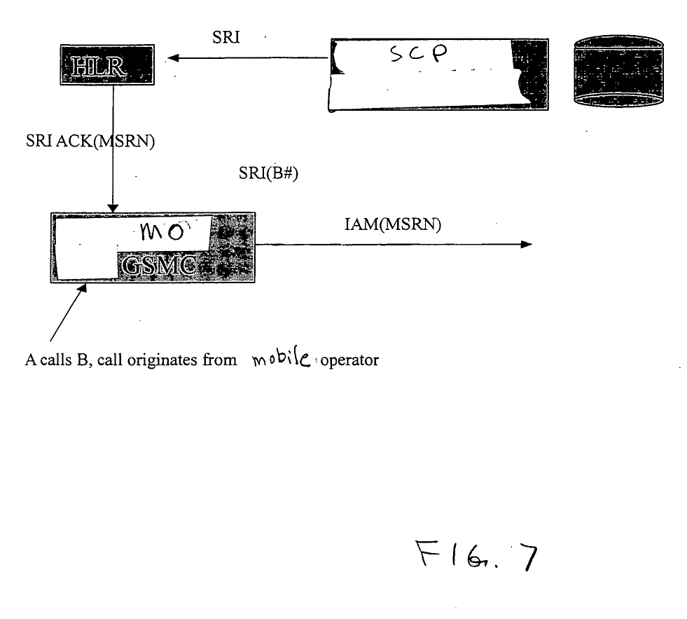

In one embodiment, another approach includes porting to a wireless phone only when the call is originated from the MO. For example, with reference to FIG. 7, if A in the MO network calls B, the MO GMSC recognizes B as a number in a portability range (e.g. via NPA_NXX from the FLO), then the MO GMSC issues SRI to the SCP. If the B# is indeed ported, the SCP issues SRI to the HLR. If not, the SCP returns the original number. The MO GMSC then routes the call normally to the FLO network.

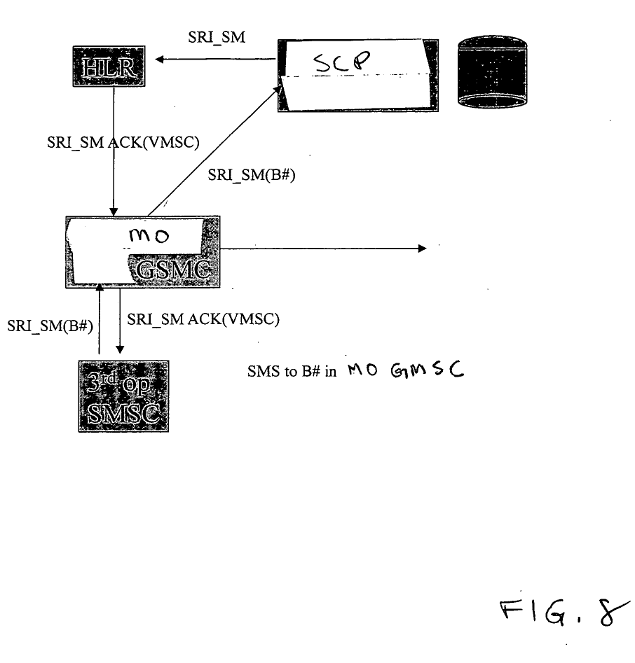

As another example, with reference to FIG. 8, an international third party SMSC sends a SMS to a B# in the MO network. The MO network has informed its roaming partners that CC/NDC range of B# belong to itself. The SMSC issues SRI-SM to the MO network.

If the SRI query for call related signaling does not involve SCCP global title translation to reach the SCP (e.g., just configuring a point code at a switch to issue SRI via SCCP), then non-call related signaling will not involve the SCP. When network elements of the MO receive non-call related signaling involving a record that does not exist, it responds with an error.

In a case in which the CdPA # is in the range of portability, and the signaling is redirected thru the SCP, the SCP checks to determine whether the CdPA is a ported number. If it is, the SCP rewrites the CdPA to the HLR; otherwise, it rejects the TCAP message.

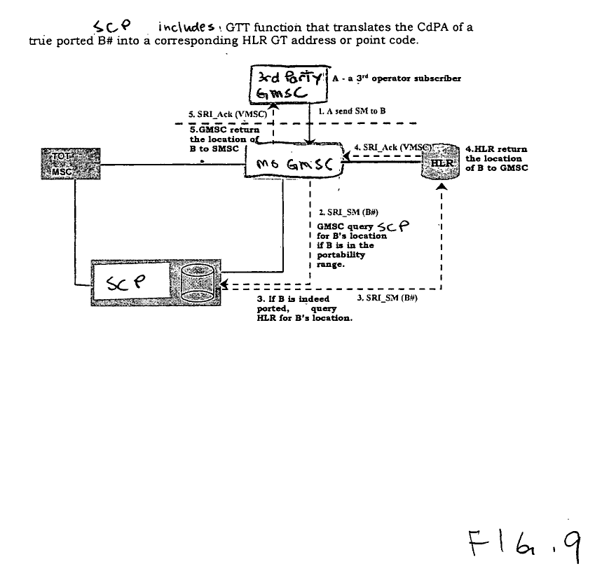

To avoid looping in the signaling, there are several options. One option is illustrated in the block diagram of FIG. 9. The SCP contains a GTT function that translates the CdPA of a true ported B# into a corresponding HLR GT address or point code.

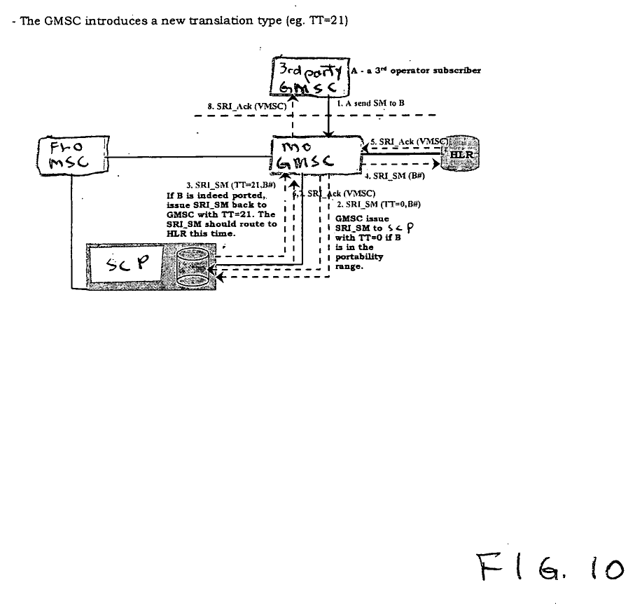

Another option is illustrated in the block diagram of FIG. 10. The MO GMSC introduces a new translation type (TT=21 for example) in such a way that when the routing is redirected through the SCP on translation type 0, the translation type is changed to 21 and routed back through the MO GMSC.

The option of FIG. 9 does not introduce a new number or translation type. However, a GTT table is maintained. The option of FIG. 10 does not introduce a number and does not include a GTT table. However, a new translation type is supported. Either option may be selected based on a variety of factors.

One embodiment of a minimum architecture configuration includes two machines (e.g., Sun, Dell/Linux, and Dell/Win). Application redundancy and DB redundancy are optional. Provisioning via Internet to add ported number is provided. The FLO uses an Internet interface to provision numbers ported to the MO network operations. The MO provisions its HLR for the ported-in numbers. Network management may be accomplished via a SNMP/MIB agent interface. Billing may follow standard call routing. Optionally, logs can be produced for billing.

Various configurations that involve the SCP, the FLO and the MO are described below. In one embodiment, the FLO and the MO assign a Signal Point Code (SPC) to the SCP. If redundancy is required, there is one SPC assigned to each SCP.

In an embodiment, the FLO performs the following configurations for the call forwarding approach:
1. Select a special number S in the number range of TOT
2. For each ported number on a switch, set the non-answer call forwarding and busy call forwarding to S.
3. configure each switch that supports ported numbers to route all calls on S to its associated tandem switch.
4. Configure on each tandem switch some ISUP loopback circuits of all calls on S thru a SCP. The number of ISUP loopback circuits depend on market projection. It is recommended to start with 4 E1. If redundancy is used, 2 E1s can go to one SCP and the other 2 E1s can go to the other SCP. The interface between the fixed line switch and SCP is ISUP signaling. There is no voice trunk involved. Several tandem switches might share SCP. The SCPs share a central DB server via IP.
5. Configure each switch on forwarding calls to S to include original B party number in the ISUP field OCN (Original Called Number) or RGN (Redirecting number).
6. Configure each tandem switch to route a special range of numbers (lets call it R, see below) from the MO towards the MO network GMSC. This may have already been.
7. If there are 2 tandem switches involved,
   a. If redundancy is required, then cross-connect the two switches ISUP loopback circuits with the 2 SCPs. That is, 2 E1 ISUP signaling links go from Tandem 1 to SCP 1; 2 E1 ISUP signaling links go from Tandem 1 to SCP 2; 2 E1 ISUP signaling links go from Tandem 2 to SCP 2 and 2 E1 ISUP signaling links go from Tandem 2 to SCP 1.
b. Otherwise, 2 E1 ISUP signaling links go from Tandem 1 to SCP 1; 2 E1 ISUP signaling links go from Tandem 2 to SCP 1.

In an embodiment, the MO performs the following configurations for the call forwarding approach:
1. Select a range of special numbers in the number range of the MO that will have calls on these numbers routed towards the MO network GMSC. Lets call the range R.
2. Configure GMSC with IN or ISUP loopback signaling on the special range of numbers R thru a SCP.
3. It is recommended to start with 4 E1s if ISUP loopback is used. If redundancy is used, 2 E1s can go to one SCP and the other 2 E1s can go to the other SCP. If the MO supports IN, IN is preferred to save circuits.
4. Configure the GMSC to have at least 2 E1 TCAP signaling links to the SCP.

5. If redundancy is used, Configure GMSC primary SCCP routing with 2 E1 TCAP signaling links can go to one SCP and the other 2 E1s can go to the other SCP.
8. If there are 2 GMSCs involved,
   a. If redundancy is required, then cross-connect the two GMSC ISUP loopback circuits and TCAP signaling links with the 2 SCP. That is, 2 E1 ISUP signaling and primary TCAP signaling links go from GMSC 1 to SCP 1; 2 E1 ISUP signaling and secondary TCAP signaling links go from GMSC 1 to Roamware SCP 2; 2 E1 ISUP signaling and primary TCAP signaling go from GMSC 2 to SCP 2 and 2E1 ISUP signaling and secondary TCAP signaling go from GMSC 2 to SCP 1.
   b. Otherwise, 2 E1 ISUP signaling and TCAP signaling links go from GMSC 1 to SCP 1; 2 E1 ISUP signaling and TCAP signaling links go from GMSC 2 to SCP 1;
6. Configure GMSC GTT (Global title translation) function in translation type 0 (TT=0) to translate SCCP CdPA=TOT-fixed-number to the DPC (destination point code) of the SCP. In this way, MAP SRI and SRI-SM query on TOT fixed numbers will come to the SCP. If redundancy is required, configure a secondary translation of TT=0 to translate SCCP CdPA=TOT-fixed-number to the DPC (destination point code) of the other SCP.
7. Configure GMSC GTT (Global title translation) function in translation type hex 21 (TT=21) to translate SCCP CdPA=FLO-fixed-number to the DPC (destination point code) of a HLR node. In this way, MAP SRI and SRI-SM query on ported FLO fixed numbers will go to the HLR directly. If the MO GMSC does not support local translation type, the SCP can just relay the SCCP query on ported TOT-fixed-numbers to the real HLRs.
8. The GMSC interface to the SCP will have both ISUP/IN and MAP interfaces.

If the call originates outside MO network, it will go to the FLO fixed line switch first before it tries the MO network. If the call originates inside the MO network, it will only go to the MO GMSC not the FLO fixed line switch. The one-way forwarding occurs because the FLO ported the number from the fixed line to the mobile operator. Since the mobile operator owns the ported subscribers, the FLO can therefore charge the MO for the forwarding calls if it desires.

For example, if the call originates outside the MO, then if the call is forwarded to the MO switch finally (e.g. because the fix-line phone is not answering), then the FLO will charge the MO for the forwarding call.

The MO can choose to charge the forwarding cost to the subscriber who uses the ported numbers for calls originated outside the MO network. It can also choose to bear the cost.

Embodiments of the invention have been described with reference to particular examples, which are not intended to be limiting. The invention is applicable to many variations of communications systems not specifically described.

The components of the telephone number portability method and system described above include any collection of computing components and devices operating together. The components of the telephone number portability method and system can also be components or subsystems within a larger computer system or network. The telephone number portability method and system components can also be coupled among any number of components (not shown), for example other buses, controllers, memory devices, and data input/output (I/O) devices, in any number of combinations. Further, functions of the telephone number portability method and system can be distributed among any number/combination of other processor-based components.

Aspects of the telephone number portability method and system described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the telephone number portability method and system include: microcontrollers with memory (such as electronically erasable programmable read only memory (EEPROM)), embedded microprocessors, firmware, software, etc. Furthermore, aspects of the telephone number portability method and system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various components disclosed herein may be described using computer aided design tools and/or expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof.

Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the telephone number portability method and system is not intended to be exhaustive or to limit the telephone number portability method and system to the precise form disclosed. While specific embodiments of, and examples for, the telephone number portability method and system are described herein for illustrative purposes, various equivalent modifications are possible within the scope of the telephone number portability method and system, as those skilled in the relevant art will recognize. The teachings of the telephone number portability method and system provided herein can be applied to other processing systems and methods, not only for the systems and methods described above.

The elements and acts of the various embodiments described above can be combined to provide further embodiments. These and other changes can be made to the telephone number portability method and system in light of the above detailed description.

In general, in the following claims, the terms used should not be construed to limit the telephone number portability method and system to the specific embodiments disclosed in the specification and the claims, but should be construed to include all processing systems that operate under the claims. Accordingly, the telephone number portability method and system is not limited by the disclosure, but instead the scope of the telephone number portability method and system is to be determined entirely by the claims.

While certain aspects of the telephone number portability method and system are presented below in certain claim forms, the inventors contemplate the various aspects of the telephone number portability method and system in any number of claim forms. Accordingly, the inventors reserve the right to add additional claims after filing the application to pursue such additional claim forms for other aspects of the telephone number portability method and system.

1. A method for communication across fixed and wireless communication networks, the method comprising:
receiving a call placed to a subscriber of a fixed line operator (FLO) network;
determining whether a called number is a potential ported number;
transmitting a message regarding the call to a service control point (SCP);
determining whether the number is a ported number; and
if the number is a ported number, returning a location routing number (LRN) to the FLO network, wherein the LRN is used to route the call to a mobile operator (MO) wireless network.

2. The method of claim 1, further comprising:
routing the call to a fixed line phone; and
routing the call to the MO network under conditions including, “no answer” and “busy”.

3. The method of claim 1, further including receiving a selection from the subscriber to disable routing to the MO network.

4. The method of claim 1, further comprising:
forwarding the call from the FLO network to the MO network, wherein the FLO routes the call from A# to B# on a C#;
routing the call on C# to a tandem switch;
issuing signaling to the SCP; and
the SCP returning a routing number to the tandem switch for routing the call to the MO network.

5. The method of claim 1, further comprising:
forwarding calls that have a call forwarding indicator, wherein the call forwarding indicator includes a single global/common C#;
routing the call to a fixed line phone first; and
on a call forwarding trigger, issuing signaling to the SCP to initiate forwarding to the MO network.

6. The method of claim 5, wherein a call forwarding trigger includes “no answer” and “busy”.

7. The method of claim 1, further comprising:
in response to a third party caller A calling a FLO subscriber B, communicating an Initial Address Message to a FLO Mobile Switching Center (MSC);
in response to a trigger, interfacing with the SCP via a SS7 transaction;
selecting a LRN;
returning the LRN back to the FLO MSC;
routing the call to the MO network;
if the LRN is in a designated range, returning control to the SCP;
returning original caller A and subscriber B numbers to the MO; and
processing the call normally in the MO network.

8. The method of claim 7, wherein the LRN is selected from a pool in a local number portability database.

9. The method of claim 1, wherein the number is a ported number if it falls in a special range of routing numbers, the method further comprising:
the SCP determining whether the number is a ported number;
if the number is a ported number, returning a LRN to a FLO Mobile Switching Center (MSC); and
building an association with the LRN in a local number portability.

10. The method of claim 9, further comprising:
the FLO MSC routing the call to a MO Gateway Mobile Switching Center (GMSC) using the LRN;
the MO GMSC generating a SS7 signaling transaction with the SCP on the special range of routing numbers;
the SCP returning the associated information with the LRN; and
releasing the LRN for reassignment.

11. The method of claim 10, wherein the special range of routing numbers includes NPA-NXX.

12. The method of claim 10, wherein the associated information includes the original called number information and the original calling number information.

13. The method of claim 1, wherein the call originates from the MO network, the method further comprising:
if a called number is a potential ported number, routing the call through the SCP via SS7 signaling;
if the number is a ported number, issuing Send Routing Information MAP message (SRI) to a Home Location Register (HLR); and
if the number is not a ported number, returning the number.

14. The method of claim 1, further comprising:
the FLO network receiving a Short Message Service (SMS) message to a B# from a Short Message Service Center (SMSC;
informing FLO roaming partners that the range of B# belong to the FLO;
the SMSC issuing SRI-SM to the MO network; and
if the B# is in a portability range, redirecting signaling through the SCP including a Signal Control Connection Part (SCCP) message.

15. The method of claim 14, further comprising:
determining whether of the B# is a ported number, including examining a CdPA;
if B# is a ported number, rewriting the CdPA to a Home Location Register (HLR): and
if B# is not a ported number, rejecting the SCCP message.

16. The method of claim 15, wherein the SCP contains a Global Title Translation function that translates the CdPA of a ported B# into a corresponding HLR Global Title (GT) address code.

17. The method of claim 15, wherein an MO Gateway Mobile Switching Center (GMSC) introduces a new translation type such that when routing is redirected through the SCP on translation type 0, the translation type is changed to the new type and routed back through the MO GMSC.

18. A system for communicating across fixed line networks and wireless networks, the system comprising:
a fixed line operator (FLO) switch, wherein the FLO switch determines whether a called number is a potential ported number;
mobile operator (MO) switch; and
a Service Control Point (SCP) coupled to the FLO switch and to the MO switch, wherein the SCP,
receives a message regarding the call when the FLO switch determines the called number is a potential ported number;
determines whether the number is a ported number; and
if the number is a ported number, returns a location routing number (LRN) to the FLO switch, wherein the LRN is used to route the call to the MO switch.

19. The system of claim 18, wherein the FLO, the MO, and the SCP communicate via ISDN User Part message from SS7 stack (ISUP) signaling.

20. The system of claim 18, wherein the FLO, the MO, and the SCP communicate via Intelligent Network (IN) signaling.

21. The system of claim 18, wherein the SCP further:
routes the call to a fixed line phone first; and
routes the call to the MO switch under conditions including, “no answer” and “busy”.

22. The system of claim 18, wherein the SCP further receives a selection from a subscriber of the FLO to disable routing to the MO switch.

23. A computer-readable medium having instructions stored thereon, which when executed, cause communication across fixed line and wireless networks, including:
receiving a call placed to a subscriber of a fixed line operator (FLO) network;
determining whether a called number is a potential ported number;
transmitting a message regarding the call to a service control point (SCP);
determining whether the number is a ported number; and
if the number is a ported number, returning a location routing number (LRN) to the FLO network, wherein the LRN is used to route the call to a mobile operator (MO) wireless network.

24. The computer-readable of claim 23, wherein communication across fixed line and wireless networks further includes:
routing the call to a fixed line phone; and
routing the call to the MO network under conditions including, “no answer” and “busy”.

25. The computer-readable of claim 23, wherein communication across fixed line and wireless networks further includes receiving a selection from the subscriber to disable routing to the MO network.

26. The computer-readable of claim 23, wherein communication across fixed line and wireless networks further includes:
forwarding the call from the FLO network to the MO network, wherein the FLO routes the call from A# to B# on a C#;
routing the call on C# to a tandem switch;
issuing signaling to the SCP; and
the SCP returning a routing number to the tandem switch for routing the call to the MO network.

27. The computer-readable of claim 23, wherein communication across fixed line and wireless networks further includes:
forwarding calls that have a call forwarding indicator, wherein the call forwarding indicator includes a single global/common C#;
routing the call to a fixed line phone first; and
on a call forwarding trigger, issuing signaling to the SCP to initiate forwarding to the MO network.

28. The computer-readable medium of claim 27, wherein a call forwarding trigger includes “no answer” and “busy”.

29. The computer-readable of claim 23, wherein communication across fixed line and wireless networks further includes:
in response to a third party caller A calling a FLO subscriber B, communicating an Initial Address Message to a FLO Mobile Switching Center (MSC);
in response to a trigger, interfacing with the SCP via a SS7 transaction;
selecting a LRN;
returning the LRN back to the FLO MSC;
routing the call to the MO network;
if the LRN is in a designated range, returning control to the SCP;
returning original caller A and subscriber B numbers to the MO; and
processing the call normally in the MO network.

30. The computer-readable medium of claim 29, wherein the LRN is selected from a pool in a local number portability database.

31. The computer-readable medium of claim 23, wherein the number is a ported number if it falls in a special range of routing numbers, communication across fixed line and wireless networks further comprising:
the SCP determining whether the number is a ported number;
if the number is a ported number, returning a LRN to a FLO Mobile Switching Center (MSC); and
building an association with the LRN in a local number portability.

32. The computer-readable medium of claim 31 communication across fixed line and wireless networks further comprising:
the FLO MSC routing the call to a MO Gateway Mobile Switching Center (GMSC) using the LRN;
the MO GMSC generating a SS7 signaling transaction with the SCP on the special range of routing numbers;
the SCP returning the associated information with the LRN; and
releasing the LRN for reassignment.

33. The computer-readable medium of claim 32, wherein the special range of routing numbers includes NPA-NXX.

34. The computer-readable medium claim 32, wherein the associated information includes the original called number information and the original calling number information.

35. The computer-readable medium claim 23, wherein the call originates from the MO network, communication across fixed line and wireless networks further comprising:
if a called number is a potential ported number, routing the call through the SCP via SS7 signaling;
if the number is a ported number, issuing Send Routing Information MAP message (SRI) to a Home Location Register (HLR); and
if the number is not a ported number, returning the number.

36. The computer-readable medium of claim 23, communication across fixed line and wireless networks further comprising:
the FLO network receiving a Short Message Service (SMS) message to a B# from a Short Message Service Center (SMSC;
informing FLO roaming partners that the range of B# belong to the FLO;
the SMSC issuing SRI-SM to the MO network; and
if the B# is in a portability range, redirecting signaling through the SCP including a Signal Control Connection Part (SCCP) message.

37. The computer-readable medium of claim 36, communication across fixed line and wireless networks further comprising:
determining whether of the B# is a ported number, including examining a CdPA;
if B# is a ported number, rewriting the CdPA to a Home Location Register (HLR): and
if B# is not a ported number, rejecting the SCCP message.

38. The computer-readable medium of claim 37, wherein the SCP contains a Global Title Translation function that translates the CdPA of a ported B# into a corresponding HLR Global Title (GT) address code.

39. The computer-readable medium of claim 37, wherein an MO Gateway Mobile Switching Center (GMSC) introduces a new translation type such that when routing is redirected through the SCP on translation type 0, the translation type is changed to the new type and routed back through the MO GMSC.
